(19) United States
(12) Patent Application Publication
(10) Pub. No.: US 2025/0370104 A1
(43) Pub. Date: Dec. 4, 2025

(54) FRAME SYNCHRONIZATION CONTROL METHOD, RECEIVING CHIP, TERMINAL DEVICE, AND STORAGE MEDIUM

(71) Applicant: SUTENG INNOVATION TECHNOLOGY CO., LTD., Shenzhen (CN)

(72) Inventor: Yan ZHAO, Shenzhen (CN)

(73) Assignee: SUTENG INNOVATION TECHNOLOGY CO., LTD., Shenzhen (CN)

(21) Appl. No.: 19/214,007

(22) Filed: May 20, 2025

(30) Foreign Application Priority Data
May 31, 2024 (CN) 202410708970.0

(51) Int. Cl. G01S 7/484; G01S 17/89

(52) U.S. Cl. CPC G01S 7/484; G01S 17/89

(57) ABSTRACT

A frame synchronization control method, a receiving chip, a terminal device, and a storage medium are provided. The frame synchronization control method includes: upon detecting a timestamp jump based on an input clock signal, updating a frame start timestamp of a current frame according to the timestamp jump value; determining a frame start timestamp of a next frame based on the updated frame start timestamp of the current frame and a frame interval; outputting a frame synchronization pulse signal when a timestamp reaches the frame start timestamp of the next frame, where the frame synchronization pulse signal is configured to trigger a LiDAR system to perform a next frame scan.

### CROSS-REFERENCE TO RELATED APPLICATION

The present application claims the benefit of priority to Chinese Patent Application No. 202410708970.0, filed on May 31, 2024, which is hereby incorporated by reference in its entirety.

### TECHNICAL FIELD

The present application pertains to the field of LiDAR technology and particularly relates to a frame synchronization control method, a receiving chip, a terminal device, and a storage medium.

### BACKGROUND

In LiDAR systems, a “frame” serves as the fundamental unit for transmitting and receiving point cloud data. A LIDAR data frame typically includes a start flag, a timestamp, a data field, and a checksum field. The start flag marks the beginning of the LiDAR data frame, while the timestamp indicates the generation time of the frame. The timestamp enables subsequent time-related calculations and supports operations such as transceiver frame synchronization and multi-sensor frame synchronization. The data field contains point cloud data, and the checksum field verifies the integrity of the point cloud data.

Timestamps play a crucial role in multi-frame synchronization, transmit and receive frame synchronization, multi-sensor frame synchronization, and distortion correction. Timestamps are generated in real-time based on system time. However, due to variations in the precision of components such as clock crystal oscillators across different devices, the system time of a LiDAR system may deviate from real-time. To align the system time with real-time as closely as possible, periodic clock calibration can be performed via the generalized Precision Time Protocol (gPTP) at the network layer to achieve clock synchronization. During this process, timestamp jumps may occur. Such timestamp jumps can affect the scan time of the LiDAR system during frame scanning, thereby compromising frame synchronization results and ultimately degrading the measurement accuracy of the LiDAR system.

### SUMMARY

Embodiments of the present application provide a frame synchronization control method, a receiving chip, a terminal device, and a storage medium, which effectively reduce the impact of timestamp jumps on frame synchronization and improve the measurement accuracy of a LiDAR system.

In a first aspect, an embodiment of the present application provides a frame synchronization control method applied to a receiving chip of a LiDAR system. The method includes: updating a frame start timestamp of a current frame based on a timestamp difference when the timestamp jump is detected according to a clock signal; determining the frame start timestamp of a next frame according to the updated frame start timestamp of the current frame and a frame interval; and outputting a frame synchronization pulse signal when a timestamp reaches the frame start timestamp of the next frame, where the frame synchronization pulse signal is configured to trigger the LiDAR system to execute a next frame scan.

In an embodiment, before updating the frame start timestamp of the current frame based on the value of the timestamp jump when the timestamp jump is detected according to the clock signal, the method further includes: determining that the timestamp jump is detected if the timestamp difference exceeds an upper timestamp jump threshold or falls below a lower timestamp jump threshold, where the timestamp difference represents a difference between a value of a currently acquired timestamp and a value of a previously acquired timestamp.

In an embodiment, before updating the frame start timestamp of the current frame based on the value of the timestamp jump when the timestamp jump is detected according to the clock signal, the method further includes: determining a timestamp source corresponding to the input clock signal based on a connection mode of the receiving chip.

In an embodiment, the LiDAR system includes multiple receiving chips connected in a cascaded configuration. For a master receiving chip, when the receiving chip is a master receiving chip, the clock signal generated by the internal clock timer of the LiDAR system is used as the timestamp source; and when the receiving chip is a slave receiving chip, the frame synchronization signal output by the master receiving chip is used as the timestamp source.

In an embodiment, when the multiple receiving chips of the LiDAR system are connected in a timestamp synchronization mode, the timestamp source for each receiving chip is determined as a clock signal generated by a local clock after clock synchronization.

In an embodiment, when the LiDAR system operates as a master sensor in a cascaded mode, a clock signal generated by an internal timer of the LiDAR system is used as the timestamp source; and when the LiDAR system operates as a slave sensor in the cascaded mode, a frame synchronization signal output from the master sensor is used as the timestamp source.

In an embodiment, for a LiDAR system operating in a timestamp synchronization mode, the timestamp source is a clock signal generated by a local clock after clock synchronization.

In an embodiment, the method further includes: outputting a frame synchronization pulse signal upon confirmation of a second boundary crossing.

In an embodiment, outputting the frame synchronization pulse signal upon confirmation of a second boundary crossing includes: confirming the second boundary crossing if a timestamp crosses a second boundary and a second pulse synchronization signal is received; and transmitting the second pulse synchronization signal to a frame pulse generator to enable the frame pulse generator to output the frame synchronization pulse signal.

In an embodiment, updating the frame start timestamp of the current frame upon detecting a timestamp jump includes: determining the frame start timestamp of the current frame based on the timestamp jump value and updating a value of a frame start timestamp cached in a latch register; or configuring a frame start timestamp offset value of the latch register as the timestamp jump value, where the latch register is configured to cache the frame start timestamp of the current frame.

In a second aspect, an embodiment of the present application provides a receiving chip, including: a timestamp jump detection module, configured to determine whether a timestamp jump exists based on an input clock signal and output a detection result when a timestamp jump exists; a frame start timestamp calculation module, connected to the timestamp jump detection module, configured to recalculate a frame start timestamp of a current frame based on a timestamp difference upon receiving the detection result indicating a timestamp jump, where the timestamp difference represents a difference between a value of a currently acquired timestamp and a value of a previously acquired timestamp; a frame start timestamp buffer module, connected to the frame start timestamp calculation module, configured to update its cached frame start timestamp of the current frame after the frame start timestamp calculation module outputs the recalculated frame start timestamp; a frame interval calculation module, configured to determine a frame interval for each frame according to frame rate configuration requirements of the LiDAR system; a pulse generation module, connected to both the frame start timestamp caching module and the frame interval calculation module, configured to determine a frame start timestamp of a next frame based on the current frame start timestamp and the frame interval, and output a frame synchronization pulse signal when a timestamp reaches the frame start timestamp of the next frame, where the frame synchronization pulse signal is configured to trigger the LiDAR system to execute a next frame scan.

In an embodiment, the receiving chip further includes: a timestamp source selection module connected to the timestamp jump detection module and the frame interval calculation module, configured to select different timestamp sources based on connection modes of the receiving chip in the LiDAR system.

In an embodiment, the receiving chip further includes: a second-crossing confirmation module connected to the pulse generation module, configured to determine whether a timestamp crosses a second boundary based on the timestamp difference, and output a second pulse synchronization signal to the pulse generation module to trigger the pulse generation module to output the frame synchronization pulse signal upon confirming a second boundary crossing and receiving the second pulse synchronization signal.

In a third aspect, an embodiment of the present application provides a terminal device. The terminal device includes a processor, a memory, and a computer program stored in the memory and executable by the processor. The processor implements the method according to the first aspect or any optional implementation of the first aspect when executing the computer program, or the terminal device includes the receiving chip according to any optional implementation of the second aspect.

In a fourth aspect, an embodiment of the present application provides a computer-readable storage medium storing a computer program. The computer program, when executed by a processor, implements the method according to the first aspect or any optional implementation of the first aspect.

In a fifth aspect, an embodiment of the present application provides a computer program product. When the computer program product runs on a terminal device, the terminal device executes the method according to the first aspect or any optional implementation of the first aspect.

The frame synchronization control method, receiving chip, terminal device, and computer-readable storage medium provided by the embodiments of the present application address the impact of timestamp jumps by updating the frame start timestamp of the current frame to align with the timestamp jump and recalculating the frame start timestamp of the next frame based on the updated value. This ensures automatic alignment of the next frame's start time, effectively counteracts the effects of timestamp jumps, and enhances the measurement accuracy of the LiDAR system.

### BRIEF DESCRIPTION OF DRA WINGS

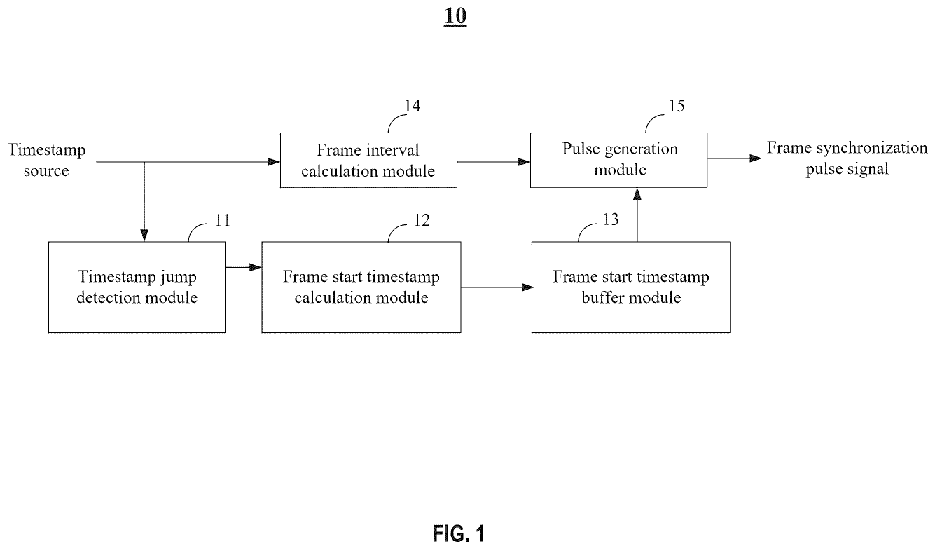

FIG. 1 is a structural schematic diagram of a receiving chip according to an embodiment of the present application;

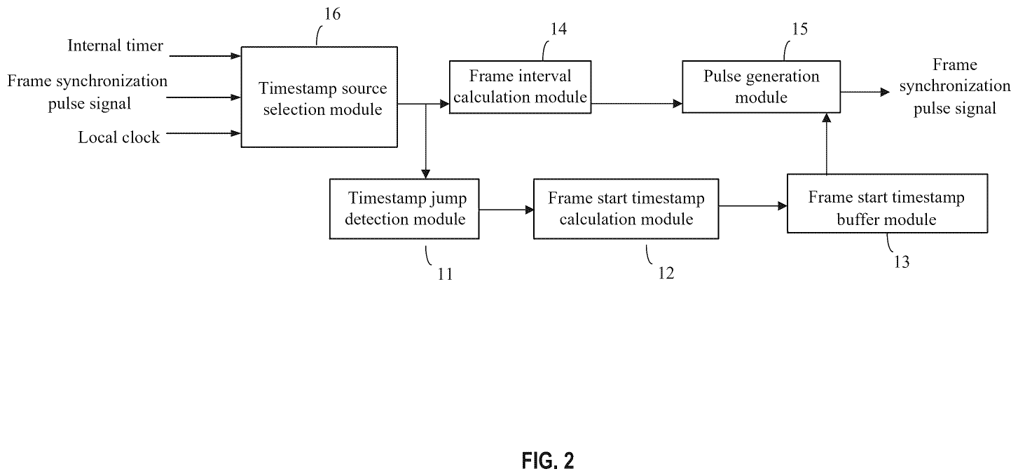

FIG. 2 is a structural schematic diagram of another receiving chip according to an embodiment of the present application;

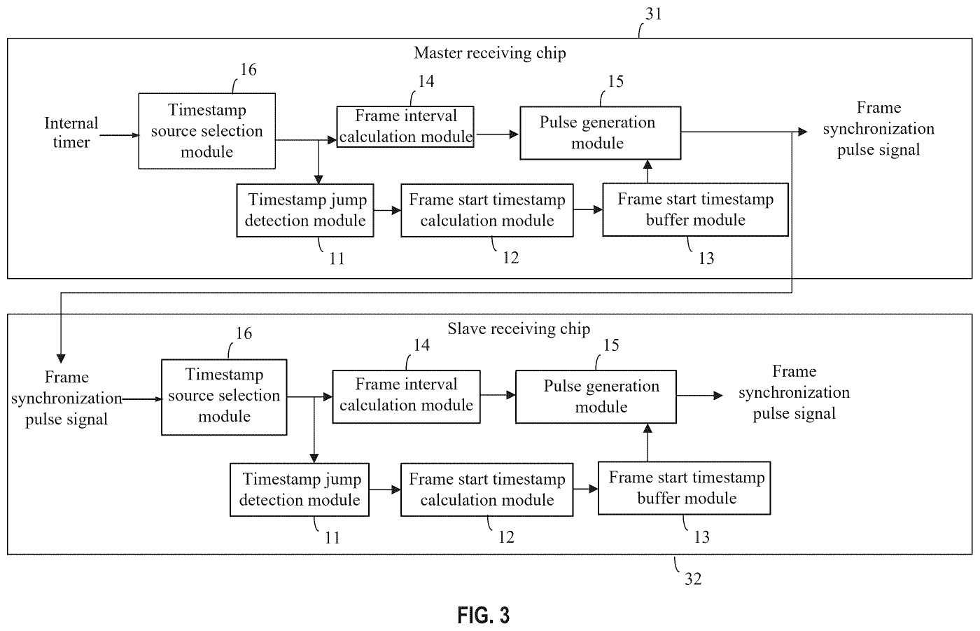

FIG. 3 is a connection schematic diagram of multiple receiving chips in a LiDAR system according to an embodiment of the present application;

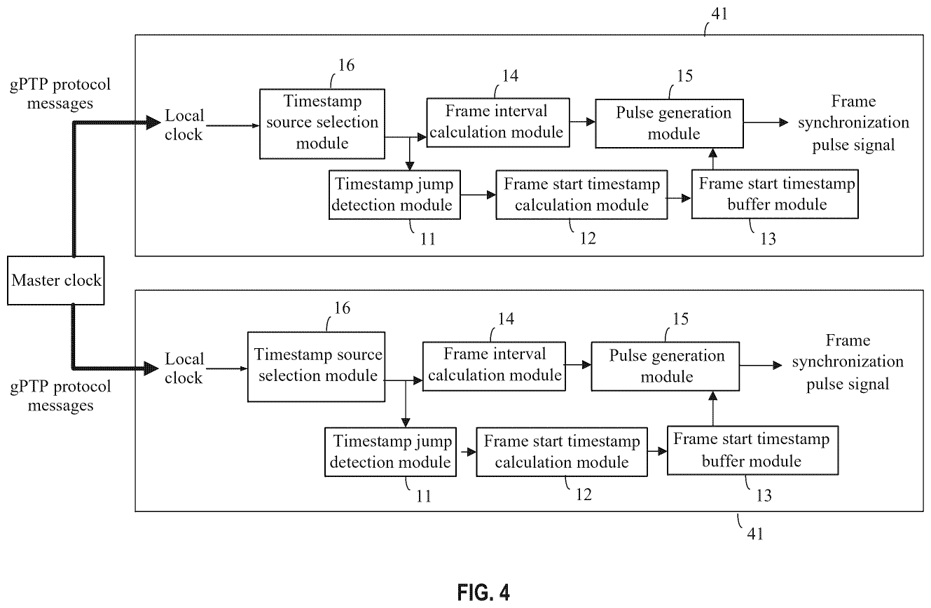

FIG. 4 is a connection schematic diagram of multiple receiving chips in another LiDAR system according to an embodiment of the present application;

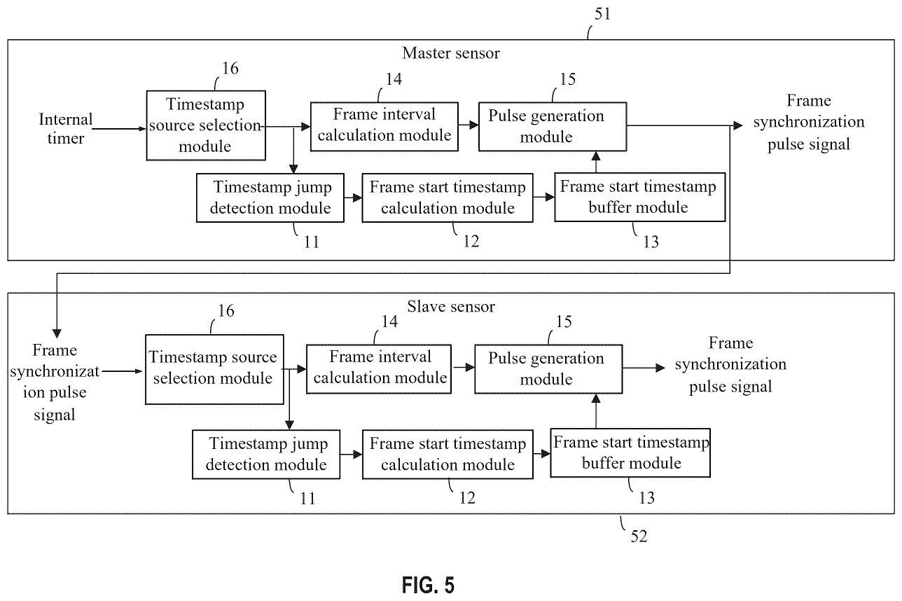

FIG. 5 is an architecture schematic diagram of a LiDAR system according to an embodiment of the present application;

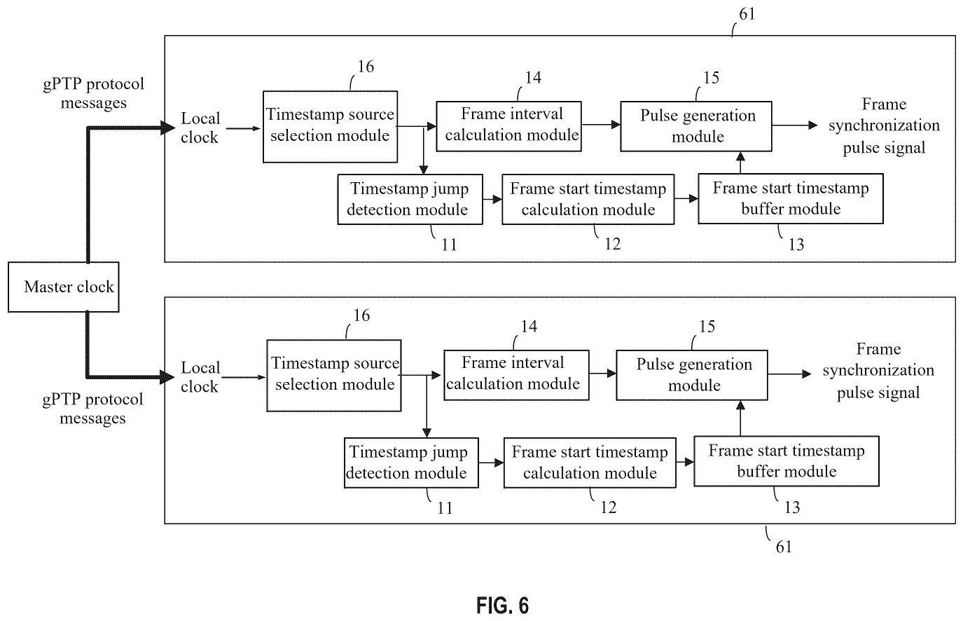

FIG. 6 is an architecture schematic diagram of another LiDAR system according to an embodiment of the present application;

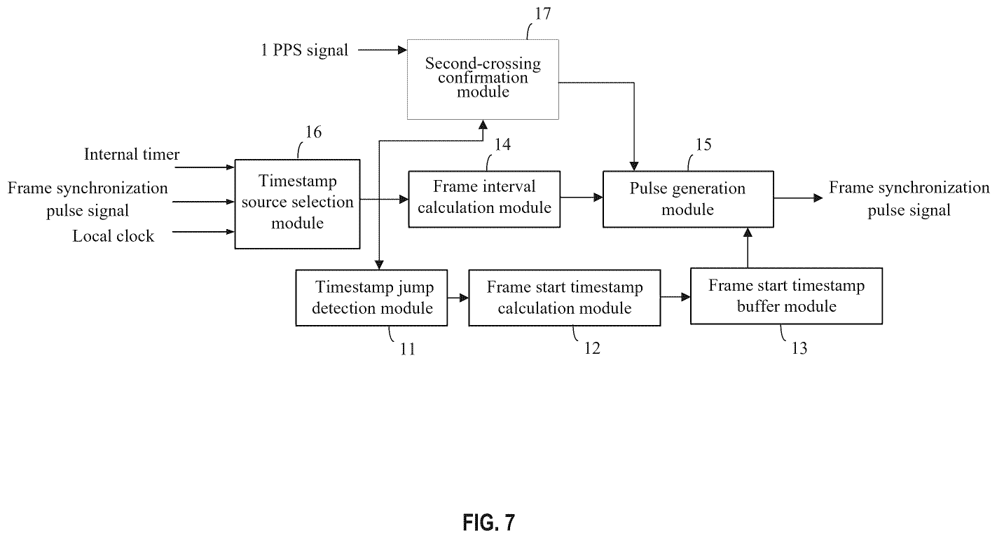

FIG. 7 is a structural schematic diagram of another receiving chip according to an embodiment of the present application;

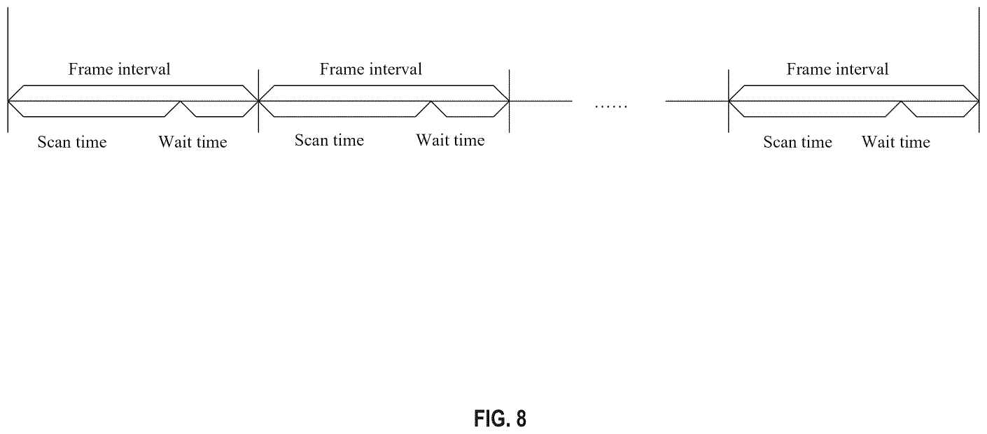

FIG. 8 is a schematic diagram illustrating a frame interval according to an embodiment of the present application;

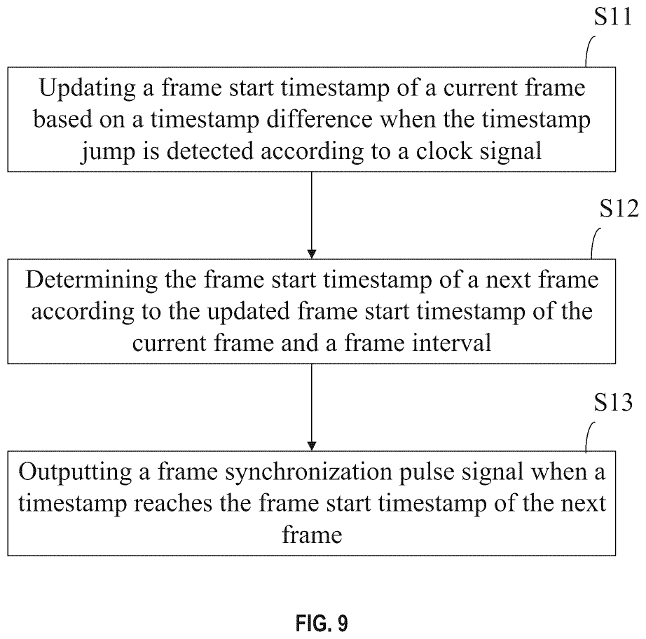

FIG. 9 is a flowchart of a frame synchronization control method according to an embodiment of the present application;

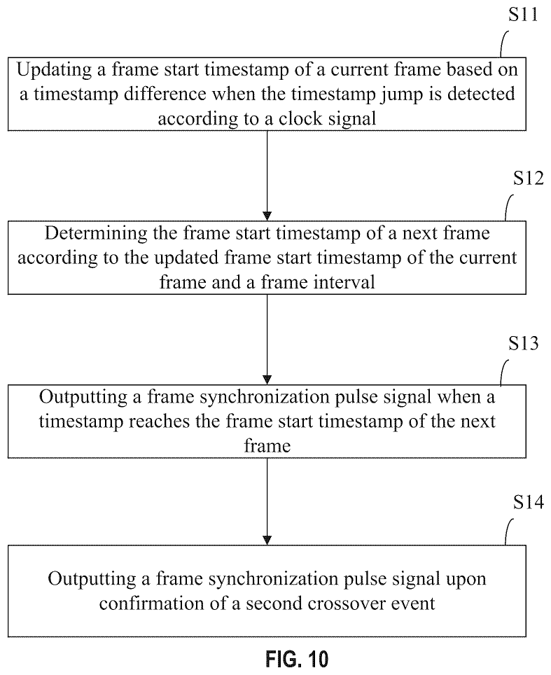

FIG. 10 is a flowchart of another frame synchronization control method according to an embodiment of the present application;

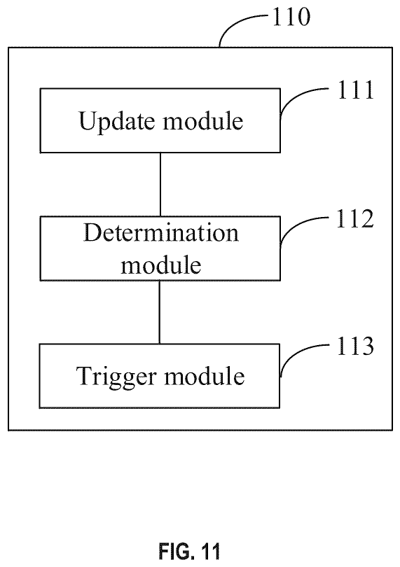

FIG. 11 is a structural schematic diagram of another receiving chip according to an embodiment of the present application;

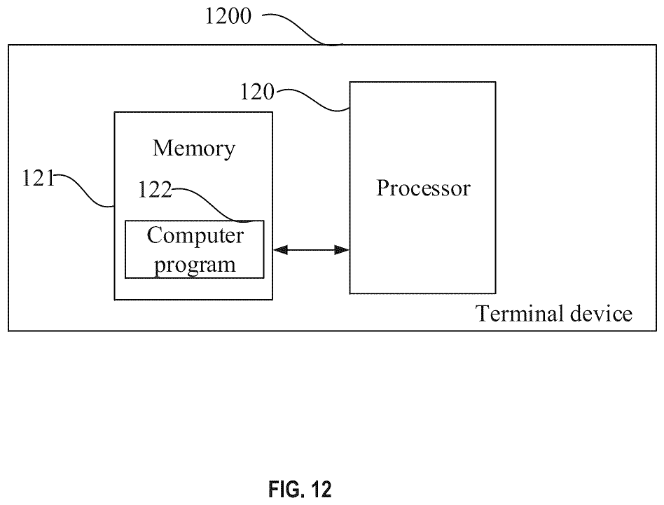

FIG. 12 is a structural schematic diagram of a terminal device according to an embodiment of the present application; and

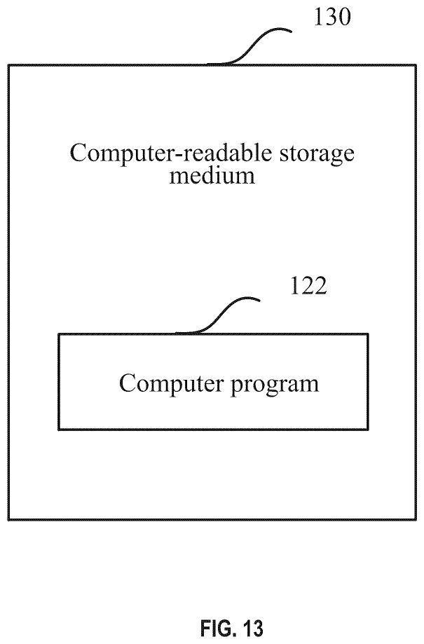

FIG. 13 is a structural schematic diagram of a chip according to an embodiment of the present application.

### DETAILED DESCRIPTION

The following descriptions include details such as system architectures and technologies for illustrative purposes only, and are not intended to limit the scope of the present application. They are provided to facilitate a thorough understanding of its embodiments. However, those skilled in the art will understand that the present application may be implemented in other embodiments without these specific details. In other instances, detailed descriptions of well-known systems, devices, circuits, and methods are omitted to avoid obscuring the description of the present application with unnecessary details.

It should be understood that the term “and/or” used in the specification and appended claims of the present application refers to any combination of one or more of the associated listed items, including all possible combinations thereof. Additionally, in the descriptions of the specification and appended claims, terms such as “first,” “second,” “third,” etc., are used solely to distinguish descriptions and should not be interpreted as indicating or implying relative importance.

It should also be understood that references to “one embodiment” or “some embodiments” in the specification of the present application mean that specific features, structures, or characteristics described in connection with the embodiment are included in one or more embodiments of the present application. Therefore, phrases such as “in one embodiment,” “in some embodiments,” “in other embodiments,” or “in further embodiments” appearing at different places in this specification do not necessarily refer to the same embodiment. Instead, they mean “one or more, but not all, embodiments,” unless explicitly emphasized otherwise. Terms such as “include,” “comprise,” “have,” and their variants mean “including but not limited to,” unless explicitly emphasized otherwise.

LiDAR (Light Detection and Ranging) is a system that emits laser beams to detect information such as the position and velocity of an object. In addition to measuring the distance of the object, it can also detect the reflectivity of the object for target identification. The operational principle of the LiDAR involves transmitting a detection signal toward the object. Upon reaching the object, the detection signal is reflected by the object, forming echo data. By receiving the reflected signal (echo data), the LiDAR determines relevant information about the object, such as distance, position, altitude, velocity, orientation, shape, and reflectivity, thereby enabling object detection, tracking, and recognition.

In a LiDAR system, a “frame” (hereinafter referred to as a LiDAR data frame) is the basic unit for transmitting and receiving point cloud data. A LiDAR data frame typically includes a start flag, timestamp, data field, and checksum field. The start flag marks the beginning of the LiDAR data frame. The timestamp marks the generation time of the LiDAR data frame. Based on the timestamp, any subsequent time-related calculations can be performed, and operations such as transmit-receive frame synchronization or multi-sensor frame synchronization can be achieved. The data field contains the point cloud data, and the checksum field verifies the integrity of the point cloud data. Frame synchronization may refer to synchronization processing between multiple frames corresponding to a single chip in a single-LiDAR system, synchronization processing between chips within a single-LiDAR system (e.g., synchronization between transmit and receive modules or between multiple receiving chips), or synchronization processing between multiple LiDARs in a multi-LiDAR system.

The timestamp in point cloud data plays a critical role in multi-frame synchronization, transmit-receive synchronization, multi-sensor synchronization, and distortion correction. The timestamp is generated in real-time based on the system time. Due to differences in the precision of components such as oscillators in clock chips across devices, the LiDAR system time may deviate from real-time. To maintain alignment between the system time and real-time, periodic clock calibration via the generalized precision time protocol (gPTP) at the network layer is performed to achieve synchronization. During this process, timestamp jumps may occur, which can affect the scanning duration of frame scans, compromise frame synchronization results, and ultimately degrade the measurement accuracy of the LiDAR system.

In practical applications, for LiDARs such as mechanical LiDAR and hybrid LiDAR (MENS LIDAR), timestamp jumps can be mitigated by adjusting the motion rate of mechanical components (e.g., oscillation or rotation speed). This compensates for the impact of timestamp jumps by aligning frame intervals.

For example, a LiDAR system may be configured to perform scans at every 10 ms interval (e.g., a first scan at 60 ms and a second scan at 70 ms). If the timestamp jumps from 60 ms to 65 ms, the motion rate of the mechanical components can be increased to ensure the LiDAR completes the previous frame scan before 70 ms, allowing the second scan to occur at 70 ms. Conversely, if the timestamp jumps from 62 ms to 59 ms (while a scan has already started at 60 ms), the motion rate can be reduced to extend the current frame scan by 3 ms, ensuring the second scan is performed precisely at 70 ms.

However, the adjustment method of controlling the motion rate of mechanical components to counteract timestamp jumps results in inconsistent frame interval durations during the adjustment period, which may adversely affect subsequent frame synchronization. In some cases, adjustments must be applied across multiple LiDAR data frames, increasing complexity. Furthermore, this method is unsuitable for LiDAR systems without mechanical components, such as solid-state array LiDARs.

To address these issues, embodiments of the present application provide a frame synchronization control method, a receiving chip, and a terminal system. When a timestamp jump is detected, the method modifies the frame start timestamp of the current frame to align with the post-jump timestamp corresponding to the current frame. Subsequently, the next frame's start timestamp is calculated based on the adjusted current frame start timestamp. This ensures automatic alignment of the next frame's start time, effectively neutralizing timestamp jump effects and enhancing the measurement accuracy of the LiDAR system.

The following provides a detailed explanation of the frame synchronization control method and receiving chip under the embodiments of the present application. Before describing the frame synchronization control method, a receiving chip according to an embodiment of the present application is first introduced.

Referring to FIG. 1, which illustrates a structural diagram of a receiving chip 10 according to an embodiment of the present application. As shown in FIG. 1, the receiving chip 10 may include a timestamp jump detection module 11, a frame start timestamp calculation module 12, a frame start timestamp buffer module 13, a frame interval calculation module 14, and a pulse generation module 15.

The timestamp jump detection module 11 is connected to both the frame start timestamp calculation module 12 and the frame interval calculation module 14. The frame start timestamp calculation module 12 is connected to the frame start timestamp buffer module 13. The pulse generation module 15 is connected to both the frame start timestamp buffer module 13 and the frame interval calculation module 14.

The timestamp jump detection module 11 is configured to determine whether a timestamp jump exists based on input clock signals.

In some embodiments, the timestamp jump detection module 11 may set a timestamp acquisition frequency, periodically collect timestamp values from the LiDAR system according to this frequency, and calculate the timestamp difference between a value of a currently acquired timestamp and a value of a previously acquired timestamp. The module then determines the presence of a timestamp jump based on this difference.

In some embodiments, predefined upper and lower thresholds for timestamp jumps can be configured. If the timestamp difference exceeds the upper threshold or falls below the lower threshold, determining the timestamp jump is detected. In such cases, the timestamp jump detection module 11 outputs a detection result indicating the presence of a timestamp jump. Additionally, this module may also output the value of the timestamp jump (i.e., the timestamp difference) to facilitate recalculation of the frame start timestamp.

The frame start timestamp calculation module 12 is triggered by the timestamp jump detection module 11 to recalculate the frame start timestamp of the current frame based on the timestamp difference. In an embodiment, when the timestamp jump detection module 11 outputs a positive detection result indicating the timestamp jump exists, it activates the recalculation process in the frame start timestamp calculation module 12.

The frame start timestamp buffer module 13 updates its cached frame start timestamp of the current frame after receiving the recalculated value from the frame start timestamp calculation module 12.

The frame interval calculation module 14 determines the frame interval for each frame according to the frame rate requirements of the LiDAR system.

The pulse generation module 15 calculates the frame start timestamp of the next frame based on the frame start timestamp of current frame and the frame interval, and outputs a frame synchronization pulse signal when the timestamp reaches the frame start timestamp of the next frame. This pulse signal triggers the LiDAR system to initiate the next frame scan.

In some embodiments, the pulse generation module 15 incorporates a frame pulse generator. When the timestamp reaches the frame start timestamp of the next frame, the frame pulse generator emits the frame synchronization pulse signal. The frame synchronization pulse signal is triggered precisely when the timestamp reaches the frame start timestamp of the next frame, which is calculated based on the cached frame start timestamp of the current frame (stored in the frame start timestamp buffer module 13). Therefore, when the frame start timestamp cached in the frame start timestamp buffer module 13 is updated to the new frame start timestamp corresponding to the timestamp jump, the pulse generation module 15 recalculates the frame start timestamp of the next frame based on the updated frame start timestamp of the current frame. This ensures that the frame start timestamp of the next frame automatically aligns with the corrected timing, thereby neutralizing the impact of the timestamp jump.

Referring to FIG. 2, in some embodiments, the receiving chip may further include a timestamp source selection module 16. This timestamp source selection module 16 is connected to both the timestamp jump detection module 11 and the frame interval calculation module 14. The timestamp source selection module 16 can select different timestamp sources based on different connection modes of the LiDAR's receiving chip.

In some embodiments, the timestamp source selection module 16 may include a multiplexer.

In some embodiments, the LiDAR system could be a single-LiDAR system containing multiple receiving chips, or a multi-LiDAR system. When the system is a single-LiDAR system with only one receiving chip, the timestamp source selection module 16 may choose the clock signal generated by internal timer of the LiDAR system as the timestamp source.

When the LiDAR system includes multiple receiving chips, their connection modes can be categorized as a cascade mode or a timestamp synchronization mode.

As shown in FIG. 3, in the cascade mode, one receiving chip among multiple receiving chips is designated as the master receiving chip 31, while others act as slave receiving chips 32. For the master receiving chip 31, the timestamp source selection module 16 selects the clock signal from the internal timer of the LiDAR system as the timestamp source. For slave receiving chips 32, the timestamp source selection module 16 selects the frame synchronization pulse signal (frame_pluse_i) output by the master receiving chip 31 as the timestamp source.

As shown in FIG. 4, in the timestamp synchronization mode, a receiving chip 41 synchronizes its local clock (tsn_slv) using periodic gPTP protocol messages containing timestamp values (timestamp) sent by the master clock (tsn_mst) on the Time Sensitive Networking (TSN) network. After achieving clock synchronization, the receiving chip 41 performs frame synchronization based on the timestamp values from local clock. Thus, the timestamp source selection module 16 chooses the clock signal generated by the synchronized local clock (tsn_slv) as the timestamp source.

When the system is a multi-LiDAR system, the connection modes between receiving chips across multi-LiDAR system can also be categorized as cascade mode or timestamp synchronization mode.

The cascade mode is suitable for scenarios with fewer sensors concentrated in distribution. As shown in FIG. 5, a cascaded LiDAR system may include a master sensor 51 and slave sensors 52. For the master sensor 51, the timestamp source selection module 16 selects clock signal generated by the internal timer as the timestamp source. For slave sensors 52, the internal timer is disabled, and the timestamp source selection module 16 selects the frame synchronization pulse signal (frame_pluse_i) output by the master sensor 51 as the timestamp source.

Timestamp synchronization mode is applicable to scenarios in LiDAR systems with numerous widely distributed sensors or requiring high real-time precision. As shown in FIG. 6, sensors 61 in LiDAR systems under timestamp synchronization mode can synchronize their local clocks (tsn_slv) with the timestamp values embedded in periodic generalized Precision Time Protocol (gPTP) messages sent by the master clock (tsn_mst) on the Time-Sensitive Networking (TSN). After achieving clock synchronization, the sensors internally perform frame synchronization based on the timestamp values from the local clock (tsn_slv), meaning the timestamp source selection module 16 will prioritize the clock signal generated by the local clock (tsn_slv) as the timestamp source.

In multi-LiDAR systems, each sensor may contain multiple receiving chips. The interconnection methods between these receiving chips can follow the configurations shown in FIG. 3 or 4, which are not reiterated herein.

In some embodiments, for LiDAR systems operating in timestamp synchronization mode, different sensors may have varying scan durations. To ensure synchronization across multiple sensors within the same LiDAR system, a second-level synchronization must be enforced during second transitions. Current implementations typically rely on a local clock outputting a 1 pulse per second (1PPS) signal at second boundaries. This 1PPS signal is directly connected to the pulse generation module 15, which terminates the waiting period upon detecting the signal after completing the last frame scan within the current second, thereby initiating the next frame scan to achieve second-level synchronization.

However, single-cycle pulses are susceptible to interference, potentially causing the 1PPS signal at integer second boundaries to either duplicate or drop. Such anomalies compromise the second-level synchronization accuracy and overall measurement precision of the LiDAR system.

To address this, in some embodiments (as depicted in FIG. 7), the receiving chip may incorporate a second-crossing confirmation module 17. The second-crossing confirmation module 17 determines whether a timestamp crosses a second boundary based on timestamp differences. If a timestamp leap-second is confirmed and the 1PPS signal is received, the second-crossing confirmation module validates the 1PPS signal as an effective synchronization pulse. The second-crossing confirmation module 17 then forwards this validated 1PPS signal to the pulse generation module 15, triggering the output of frame synchronization pulses.

Here, by implementing a dual second-crossing confirmation logic, the frame synchronization pulse signal is triggered through the second-crossing confirmation module 17 only when both the second pulse synchronization signal is received and the timestamp leap-second is confirmed. This enhances the accuracy of frame synchronization pulse signal triggered by the second pulse synchronization signal, further improving the measurement precision of the LiDAR system.

It should be noted that when configuring frame rates, the LiDAR system typically reserves a waiting period. As shown in FIG. 8, the frame interval (frame_interval) includes scan time (scan_time) and wait time (wait_time). The LiDAR system completes scanning during the scan time, which represents the actual duration for transmission and reception, while the wait time is idle. Both the frame synchronization control method and second synchronization method can be executed during this wait time. The frame interval refers to the duration between the start timestamp of the current frame and the start timestamp of the next frame.

Having described the receiving chip embodiment, the following details the frame synchronization control method. This method can be implemented using the aforementioned receiving chip or through software in the LiDAR system's control system, without specific limitations. Using the control system as the execution entity, the method proceeds as follows.

Refer to FIG. 9, which illustrates the workflow of the frame synchronization control method. As shown, the method includes steps S11 to S13.

In S11: updating a frame start timestamp of a current frame based on a timestamp difference when the timestamp jump is detected according to a clock signal.

In an embodiment, the LiDAR system periodically samples timestamp values at a predefined acquisition frequency, calculates the difference between the current and previous timestamps, and determines timestamp jumps based on the timestamp difference.

In an embodiment, the system predefines upper and lower thresholds for timestamp jumps. A timestamp difference exceeding the upper threshold or falling below the lower threshold confirms the occurrence of the timestamp jump.

It should be noted that the aforementioned detection of timestamp jumps can be implemented either by the timestamp jump detection module within the receiving chip or through software monitoring, as the present application imposes no specific limitations.

In an embodiment, when the timestamp jump detection module identifies a timestamp jump, the frame start timestamp calculation module 12 may recalculate the frame start timestamp of the current frame based on the timestamp difference.

In some embodiments, the recalculated frame start timestamp may replace the originally buffered frame start timestamp of the current frame in the frame start timestamp buffer module 13, thereby updating the frame start timestamp after the timestamp jump.

In an embodiment, the timestamp buffer module 13 may include a latch register, where the frame start timestamp of the current frame is stored.

In some embodiments, when timestamp jump detection is implemented via software, the latch register's access permissions may be granted to the software, allowing updates to the frame start timestamp of the current frame through register configuration.

In some embodiments, the frame start timestamp of the current frame stored in the latch register can be directly updated by configuring the value of the frame start timestamp (Csr_fram_ts_updt). In some embodiments, the latch register may recalculate the frame start timestamp of the current frame by configuring the difference between old frame start timestamps and new frame start timestamps. For example, the timestamp difference (i.e., the value of the timestamp jump) before the timestamp jump and after the timestamp jump is configured as the frame start timestamp offset value (Csr_fram_ts_offset) in the latch register, thereby updating the frame start timestamp stored in the latch register.

In some embodiments, different timestamp sources may be selected based on the receiving chip's connection configuration within the LiDAR system. The LiDAR system could be a single-LiDAR or multi-LiDAR system. For a single-LiDAR system containing only one receiving chip, the chip may select the clock signal generated by the LiDAR system's internal timer as the timestamp source.

When a single-LiDAR system includes multiple receiving chips, the connection modes of the receiving chips may include cascade mode and timestamp synchronization mode.

In cascade mode, one receiving chip is designated as the master receiving chip while others serve as slave receiving chips. For the master receiving chip, the timestamp source selection module 16 may choose clock signals generated by the LiDAR system's internal timer as the timestamp source. For slave receiving chips, the timestamp source selection module 16 may select the frame synchronization pulse signal (frame_pulse_i) output by the master receiving chip as the timestamp source.

In timestamp synchronization mode, receiving chips synchronize their local clocks (tsn_slv) using timestamp values (timestamp) extracted from periodic gPTP protocol messages transmitted by the master clock (tsn_mst) over a Time Sensitive Networking (TSN) network. After achieving clock synchronization via the local clock (tsn_slv), the receiving chips perform frame synchronization based on the timestamp of the local clock. The timestamp source selection module 16 selects clock signals generated by the local clock (tsn_slv) as the timestamp source.

When the LiDAR system operates as a multi-LiDAR system, it can similarly adopt cascade mode or timestamp synchronization mode.

Cascade mode is suitable for scenarios with fewer sensors concentrated in a localized area. In such a cascaded LiDAR system, a master sensor uses clock signals from its internal timer as the timestamp source, while slave sensors deactivate their internal timers and instead use the frame synchronization pulse signal (frame_pulse_i) outputted by the master sensor as the timestamp source.

Timestamp synchronization mode applies to systems with numerous distributed sensors or those requiring high real-time precision. In this mode, sensors synchronize their local clocks (tsn_slv) using timestamp from periodic gPTP protocol messages transmitted by the TSN master clock (tsn_mst). After synchronization, the sensors internally perform frame synchronization using the value of the timestamp from the synchronized local clock (tsn_slv), effectively selecting clock signals of the synchronized local clock (tsn_slv) as the timestamp source.

In S12, determining the frame start timestamp of a next frame according to the updated frame start timestamp of the current frame and a frame interval.

In an embodiment, after updating the frame start timestamp of the current frame, the LiDAR system recalculates the frame start timestamp of the next frame using the adjusted timestamp and predefined frame interval. Notably, the frame interval is configurable based on frame rate requirements.

In S13, outputting a frame synchronization pulse signal when a timestamp reaches the frame start timestamp of the next frame.

In an embodiment, the frame synchronization pulse signal is output via a pulse generator to trigger the next frame scan of the LiDAR system.

In an embodiment, when timestamp_cur equals the sum of timestamp_last and frame_interval, the frame synchronization pulse signal (frame_pulse_o) is activated to achieve frame alignment, where timestamp_cur denotes the current timestamp, timestamp_last represents the frame start timestamp of the current frame, and frame_interval is the configured frame duration.

This methodology demonstrates how the frame synchronization control method dynamically adjusts the frame start timestamp of the current frame upon detecting timestamp jumps, recalculates subsequent frame timestamps accordingly, and ensures automatic alignment of frame intervals. This effectively neutralizes timestamp jump distortions and enhances LiDAR measurement precision.

Referring to FIG. 10, which illustrates an expanded implementation flow, the method may include additional step S14.

S14, outputting a frame synchronization pulse signal upon confirmation of a second crossover event.

In some embodiments, the LiDAR system identifies second boundaries using the clock signal of the local clock. When the local clock generates a second pulse synchronization signal during boundary transitions, the LiDAR system outputs the frame synchronization pulse to initiate the next frame scan, thereby achieving second-level synchronization.

In some embodiments, the LiDAR system may also determine whether the timestamp crosses a second boundary based on the timestamp difference. If a second boundary crossing is confirmed and a second pulse synchronization signal is received, the system outputs the second pulse synchronization signal to the frame pulse generator to trigger the generation of a frame synchronization pulse signal.

By implementing a dual-confirmation logic for second boundary crossing—requiring both the reception of the second pulse synchronization signal and verification of timestamp-based second boundary crossing—the accuracy of frame synchronization triggered by the second pulse signal is enhanced, further improving the LiDAR system's measurement precision.

It should be understood that the numerical order of steps in the above embodiments does not imply their execution sequence. The execution order of each process should be determined based on its functionality and inherent logic, and should not be construed as limiting the implementation of the embodiments of the present application.

Building upon the frame synchronization control method described in the preceding embodiments, the present application further provides an embodiment of a receiving chip.

Refer to FIG. 11, which illustrates a structural diagram of a receiving chip according to an embodiment of the present application. In this embodiment, each unit within the receiving chip executes the steps outlined in the corresponding embodiment of FIG. 9. For details, refer to FIG. 9 and its associated description. Only components relevant to this embodiment are shown for clarity. As depicted in FIG. 11, the receiving chip 110 includes update module 111, determination module 112, and trigger module 113.

Update module 111 is configured to update a frame start timestamp of a current frame based on a timestamp difference when the timestamp jump is detected according to a clock signal.

Determination module 112 is configured to determine the frame start timestamp of a next frame according to the updated frame start timestamp of the current frame and a frame interval.

Trigger module 113 is configured to output a frame synchronization pulse signal when a timestamp reaches the frame start timestamp of the next frame.

In some embodiments, the receiving chip 110 may additionally include a second synchronization module configured to output the frame synchronization pulse signal upon confirming a second boundary crossing.

Note that the information exchange and execution processes among these modules align with the methodology described in the method embodiments. For functional details and technical effects, refer to the corresponding method embodiments, which will not be reiterated here.

Therefore, the receiving chip provided in the embodiments of the present application can also, upon detecting a timestamp jump, modify the frame start timestamp of the current frame to the post-jump timestamp corresponding to the current frame. It then calculates the frame start timestamp of the next frame based on the adjusted frame start timestamp of the current frame, enabling automatic alignment of subsequent frame start times. This effectively neutralizes the impact of timestamp jumps and enhances the measurement accuracy of LiDAR system.

FIG. 12 illustrates a structural diagram of a terminal device according to an embodiment of the present application. As shown in FIG. 12, the terminal device 1200 includes a processor 120, a memory 121, and a computer program 122 (e.g., an image segmentation program) stored in the memory 121 and executable by the processor 120. When executing the computer program 122, the processor 120 implements the steps in the frame synchronization control method embodiments described earlier, such as steps S11-S13 shown in FIG. 9. In some embodiments, the processor 120 executes the computer program 122 to realize the functions of modules/units in the terminal device embodiments, such as the functions of units 111-113 shown in FIG. 11.

In an embodiment, the computer program 122 may be divided into one or more modules/units. These modules/units are stored in the memory 121 and executed by the processor 120 to accomplish the objectives of the present application. The one or more modules/units may include a series of computer program instruction segments capable of performing specific functions, which describe the execution process of the computer program 122 in the terminal device 1200. For example, the computer program 122 may be divided into an acquisition unit, a determination unit, and a calculation unit. Detailed functionalities of these units can be found in the corresponding descriptions of the embodiments associated with FIG. 11 and are not repeated here.

The terminal device may include, but is not limited to, the processor 120 and the memory 121. Those skilled in the art will recognize that FIG. 12 is merely an example of the terminal device 1200 and does not limit its configuration. The terminal device may incorporate more or fewer components than illustrated, combine certain components, or use different components, such as input/output devices, network interfaces, or buses.

The processor 120 may be a Central Processing Unit (CPU), a general-purpose processor, a Digital Signal Processor (DSP), an Application-Specific Integrated Circuit (ASIC), a Field-Programmable Gate Array (FPGA), other programmable logic devices, discrete gate or transistor logic devices, or discrete hardware components. A general-purpose processor may be a microprocessor, or the processor may be any conventional processor.

The aforementioned memory 121 may be an internal storage unit of the terminal device 1200, such as a hard disk or memory of the terminal device 1200. The aforementioned memory 121 may also be an external storage device of the terminal device 1200, such as a plug-in hard disk equipped on the terminal device 1200, a Smart Media Card (SMC), a Secure Digital (SD) card, a Flash Card, etc. Furthermore, the aforementioned memory 121 may include both the internal storage unit of the terminal device 1200 and external storage devices. The memory 121 is configured to store the aforementioned computer program as well as other programs and data required by the terminal device. The memory 121 may also be used to temporarily store data that has been output or is to be output.

Embodiments of the present application further provide a computer-readable storage medium. As shown in FIG. 13, which illustrates the structure of a computer-readable storage medium 130. The computer-readable storage medium 130 stores a computer program 122. When executed by a processor, the computer program 122 implements the aforementioned frame synchronization control method.

Embodiments of the present application also provide a computer program product. When the computer program product runs on a terminal device, it enables the terminal device to execute and implement the aforementioned frame synchronization control method.

Those skilled in the art may clearly understand that, for convenience and brevity of description, the division of the above functional units/modules is merely illustrative. In practical applications, the above functions may be allocated to different functional units/modules as needed, meaning that the internal structure of the terminal device may be divided into different functional units or modules to perform all or part of the described functions. The functional units/modules in the embodiments may be integrated into a single processing unit, exist as separate physical entities, or be integrated into multiple units. These integrated units may be implemented in hardware or software functional modules. Additionally, the specific names of the functional units/modules are solely for distinguishing purposes and do not limit the scope of protection of the present application. For specific operational processes of the units/modules in the above system, reference may be made to corresponding processes in the preceding method embodiments, which will not be repeated here.

In the above embodiments, descriptions of each embodiment emphasize different aspects. For parts not detailed or recorded in a specific embodiment, reference may be made to related descriptions in other embodiments.

Those skilled in the art may recognize that the units and algorithm steps described in the examples disclosed in the embodiments herein can be implemented through electronic hardware, or a combination of computer software and electronic hardware. Whether these functions are executed via hardware or software depends on specific applications and design constraints of the technical solutions. Professionals may implement the described functionalities using different methods for each specific application. However, such implementations shall not be considered as exceeding the scope of the present application.

The above embodiments are intended to illustrate the technical solutions of the present application but not to limit them. Although detailed descriptions are provided with reference to the foregoing embodiments, those of ordinary skill in the art should understand that modifications to the technical solutions described in the aforementioned embodiments or equivalent substitutions of partial technical features may still be made. Such modifications or substitutions shall not render the essence of the corresponding technical solutions to depart from the spirit and scope of the technical solutions in the embodiments of the present application, and all such changes shall fall within the protection scope of the present application.

What is claimed is:

1. A frame synchronization control method for a receiving chip of a LiDAR system, comprising:
updating a frame start timestamp of a current frame based on a timestamp difference when the timestamp jump is detected according to a clock signal;
determining the frame start timestamp of a next frame according to the updated frame start timestamp of the current frame and a frame interval; and
outputting a frame synchronization pulse signal when a timestamp reaches the frame start timestamp of the next frame, wherein the frame synchronization pulse signal is configured to trigger the LiDAR system to execute a next frame scan.

2. The frame synchronization control method according to claim 1, wherein before updating the frame start timestamp of the current frame based on a value of the timestamp jump when the timestamp jump is detected according to the clock signal, the method further comprises:
determining that the timestamp jump is detected if the timestamp difference exceeds an upper timestamp jump threshold or falls below a lower timestamp jump threshold; and
wherein the timestamp difference represents a difference between a value of a currently acquired timestamp and a value of a previously acquired timestamp.

3. The frame synchronization control method according to claim 1, wherein before updating the frame start timestamp of the current frame based on a value of the timestamp jump when the timestamp jump is detected according to the clock signal, the method further comprises:
determining a timestamp source corresponding to an input clock signal based on a connection mode of the receiving chip.

4. The frame synchronization control method according to claim 3, wherein the LiDAR system comprises multiple receiving chips connected in a cascaded configuration;
when the receiving chip is a master receiving chip, the clock signal generated by an internal clock timer of the LiDAR system is used as the timestamp source; and
when the receiving chip is a slave receiving chip, the frame synchronization signal output by the master receiving chip is used as the timestamp source.

5. The frame synchronization control method according to claim 4, further comprising:
determining the timestamp source for each receiving chip as the clock signal generated by a local clock after clock synchronization, when the multiple receiving chips of the LiDAR system are connected in a timestamp synchronization mode.

6. The frame synchronization control method according to claim 3, further comprising:
using the clock signal generated by an internal timer of the LiDAR system as the timestamp source, when the LiDAR system operates as a master sensor in a cascaded mode; or
using the frame synchronization signal output from the master sensor as the timestamp source, when the LiDAR system operates as a slave sensor in the cascaded mode.

7. The frame synchronization control method according to claim 3, wherein:
for the LiDAR system operating in a timestamp synchronization mode, the timestamp source is a clock signal generated by a local clock after clock synchronization.

8. The frame synchronization control method according to claim 1, further comprising:
outputting a frame synchronization pulse signal upon confirmation of a second boundary crossing.

9. The frame synchronization control method according to claim 8, wherein outputting the frame synchronization pulse signal upon confirmation of a second boundary crossing comprises:
confirming the second boundary crossing if a timestamp crosses a second boundary and a second pulse synchronization signal is received; and
upon confirmation of the second boundary crossing, transmitting the second pulse synchronization signal to a frame pulse generator to enable the frame pulse generator to output the frame synchronization pulse signal.

10. A receiving chip, comprising:
a timestamp jump detection module, configured to determine whether a timestamp jump exists based on an input clock signal and output a detection result when a timestamp jump exists;
a frame start timestamp calculation module, connected to the timestamp jump detection module, configured to recalculate a frame start timestamp of a current frame based on a timestamp difference upon receiving the detection result indicating a timestamp jump, wherein the timestamp difference represents a difference between a value of a currently acquired timestamp and a value of a previously acquired timestamp;
a frame start timestamp buffer module, connected to the frame start timestamp calculation module, configured to update its cached frame start timestamp of the current frame after the frame start timestamp calculation module outputs the recalculated frame start timestamp;
a frame interval calculation module, configured to determine a frame interval for each frame according to frame rate configuration requirements of a LiDAR system; and
a pulse generation module, connected to both the frame start timestamp caching module and the frame interval calculation module, configured to determine a frame start timestamp of a next frame based on the current frame start timestamp and the frame interval, and output a frame synchronization pulse signal when a timestamp reaches the frame start timestamp of the next frame, wherein the frame synchronization pulse signal is configured to trigger the LiDAR system to execute a next frame scan.

11. A terminal device, comprising a memory, a processor, and a computer program stored in the memory and executable by the processor, wherein the computer program, when executed by the processor, causes the processor to perform operations comprising:
updating a frame start timestamp of a current frame based on a timestamp difference when the timestamp jump is detected according to a clock signal;
determining the frame start timestamp of a next frame according to the updated frame start timestamp of the current frame and a frame interval; and
outputting a frame synchronization pulse signal when a timestamp reaches the frame start timestamp of the next frame, wherein the frame synchronization pulse signal is configured to trigger a LiDAR system to execute a next frame scan.
